(19) United States
(12) Patent Application Publication
(10) Pub. No.: US 2005/0122713 A1
(43) Pub. Date: Jun. 9, 2005

(54) Lighting

(76) Inventor: Donald C. Hutchins, Longmeadow, MA (US)

Correspondence Address: FISH & RICHARDSON PC, 225 FRANKLIN ST, BOSTON, MA, 02110, US

(21) Appl. No.: 10/727,265

(22) Filed: Dec. 3, 2003

(51) Int. Cl. F21L 4/04; F21V 29/00

(52) U.S. Cl. 362/205; 362/294

(57) ABSTRACT

In one aspect, there is a lithium battery powered LED light. The light includes a lithium battery power source, a switch, and a Gallium Nitride Light Emitting Diode (LED) selectively electrically connected to the lithium battery by the switch. The light also includes a heat sink thermally coupled to the LED and a voltage converter and current regulator circuit having a circuit contact electrically connected to the switch. The LED and the lithium battery are constructed and arranged to provide a predetermined voltage and current to the LED when connected to the lithium battery. The light also includes a housing within which the lithium battery, the switch, the LED, the heat sink and the voltage converter and current regulator circuit are located.

### BACKGROUND OF THE INVENTION

For background, reference is made to the following U.S. Pat. Nos. 4,577,263; 4,656,565; 4,658,336; 4,819,141; 4,851,974; 4,899,265; 4,942,505; 4,963,798; 5,003,440; 5,442,528; 5,642,932; 5,865,524; 6,046,572; 6,019,482; 6,168,288; 6,222,138;

### SUMMARY OF THE INVENTION

In one aspect, there is a lithium battery powered LED light. The light includes a lithium battery power source, a switch, and a Gallium Nitride Light Emitting Diode (LED) selectively electrically connected to the lithium battery by the switch. The light also includes a heat sink thermally coupled to the LED and a voltage converter and current regulator circuit having a circuit contact electrically connected to the switch. The LED and the lithium battery are constructed and arranged to provide a predetermined voltage and current to the LED when connected to the lithium battery. The light also includes a housing within which the lithium battery, the switch, the LED, the heat sink and the voltage converter and current regulator circuit are located.

In other examples, the light can include one or more of the following features. The housing includes a metal body that includes the heat sink. The housing includes a metal body having threaded parts that include the switch, which is closed when the threaded parts of the housing are screwed together in a first direction, thereby urging the lithium battery against the circuit contact, causing activation of the voltage converter and current regulator circuit and causing the LED to emit light. The light can include a compressed rubber ring configured to urge the battery away from the circuit contact and deactivate the voltage converter and current regulator circuit when the threaded parts of the housing are turned in a second direction opposed to the first direction. The threaded parts include outside-diameter threads and inside-diameter threads that are moveably coupled to each other. The lithium battery and the Gallium Nitride LED are constructed and arranged to have a shelf life of at least 10 years.

In other examples, the light includes a collimator optically coupled to the LED. The collimator includes an optical-grade-acrylic-plastic. The collimator is constructed and arranged to produce a substantially 10-degree light beam when the LED is on. The collimator is integrally coupled to the housing, thereby acting as a protective lens at a front end of the light to protect the LED and electronic components included within the housing. The LED is constructed and arranged to emit light waves at a frequency that is seen by the human eye as blue/green or teal in color. The LED has a brightness such that the LED can be seen from a distance of over 1 mile. The voltage converter and current regulator circuit is constructed and arranged to provide at least 85% power efficiency.

In other examples, the LED is permanently mounted on a metal circuit board holder that includes a thermally conductive path thermally coupled to the LED and a metal body of the housing. The metal circuit board holder includes a first passage. The light includes a one-sided circuit board that includes a second passage aligned with the first passage. The light also includes a connecting wire passing through the first and second passages, where the connecting wire is electrically connected to the circuit board and to a contact for the lithium battery. The light also includes a cavity defined by the housing within which portions of the connecting wire are stored. The housing includes a polished metal in the form of a column. The housing does not include any switches or buttons external to the housing. The LED is electrically connected to an electronic circuit board that includes the voltage converter and current regulator circuit. The electronic circuit board is a one-sided circuit board and the lithium battery is located on a side of the circuit board opposite of where the LED is located. The circuit board includes a passage that is constructed and arranged to allow a wire connected to the LED to pass through the passage in the circuit board to a connection that is in contact with the battery.

In other examples, the voltage converter and current regulator circuit is constructed and arranged to provide a minimum of 2.7 volts to the Gallium Nitride LED. The Gallium Nitride LED is a 1-watt LED and the Lithium battery is a 3-volt lithium battery. The voltage converter and current regulator circuit is constructed and arranged to power the 1-watt Gallium Nitride LED using the 3-volt lithium battery. The voltage converter and current regulator circuit is constructed and arranged to allow the 3-volt lithium battery to provide at least six hours of continual light from the 1-watt LED. The voltage converter and current regulator circuit includes an inductor electrically connected to the switch and a Schottky type diode including an anode side and a cathode side, were the anode side electrically connected to the inductor. The circuit also includes a current sensing resistor electrically connected to the LED, an output capacitor electrically connected to the cathode side of the Schottky type diode, and a switching transistor electrically connected to the anode side of the Schottky type diode. The circuit also includes a voltage converter and current regulator controller IC that includes a voltage sense port electrically connected to the inductor, a current sensing port electrically connected to the current sensing resistor, and a transistor driving port electrically connected to the switching transistor.

Numerous other features, objects and advantages of the invention will become apparent from the following detailed description when read in connection with the accompanying drawing in which:

### BRIEF DESCRIPTION OF THE SEVERAL VIEWS OF THE DRAWING

FIGS. 1A and 1B are outline drawings of a side view and a front view of a battery-powered LED light according to the invention;

FIG. 2 is a cross sectional view of the light of FIGS. 1A and 1B;

FIG. 3 is an assembly drawing of a portion of the light of FIGS. 1A and 1B; and

FIG. 4 is a circuit diagram of an exemplary circuit used in the portable battery-powered light according to the invention.

### DETAILED DESCRIPTION

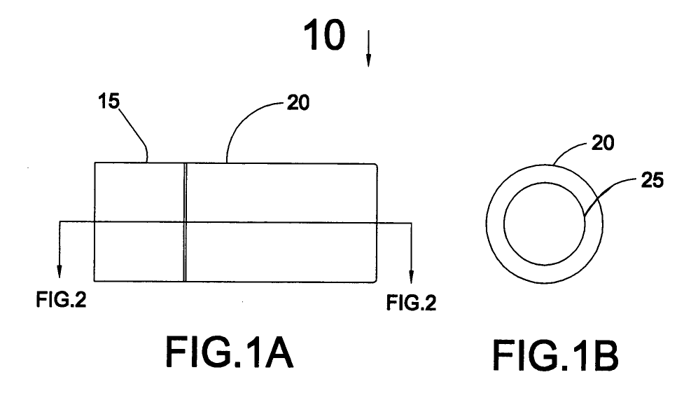

FIGS. 1A and 1B illustrate a portable battery-powered LED light 10 according to the invention. FIG. 1A illustrates a side view of the light 10. The housing of light 10 includes a first portion 15 and a second portion 20. As described in more detail below, a user rotates one of the portions (e.g., 15 or 20) while holding the other stationary to turn light 10 on and off. FIG. 1B illustrates a front view of light 10. The front view shows a lens 25 within the second portion 20 of the housing.

In one embodiment, the appearance of light 10 is that of a simple, polished metal column with no outside switches or buttons. All that is seen is the outside surface of a body of first portion 15 that abuts the outside surface of a cylindrical head of second portion 20. The bottom end body (e.g., at first portion 15) is flat and the top end (e.g., at second portion 20) has a round opening with the collimator/lens 25 recessed away from the face. This elegant appearance advantageously enables light 10 to be unobtrusive and ornaments a supporting office desk or piece of furniture while readily accessible for use.

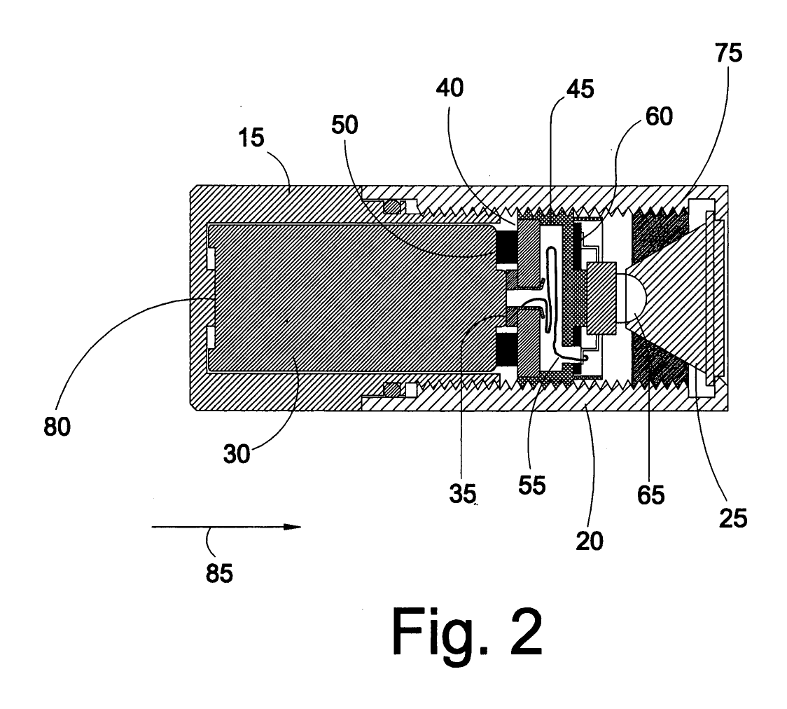

FIG. 2 shows a cross sectional view of light 10. The illustrated example includes a metal barrel at portion 15 having an elongated, hollow, tubular body closed at one end ready to accept and hold a single lithium battery 30. Part of the outside diameter of the barrel of portion 15 is threaded.

The cylindrical shaped lithium battery 30 is inserted in the barrel 15 and used as the power source that powers light 10. A metal electrical contact 35 is staked into a nonconductive cover 40 that is pressed into and encloses one end of a metal circuit board holder 45. The nonconductive cover 40 has a counter-bore, which is used to capture a donut shaped rubber gasket 50 that acts as a spring to force the battery 30 away from the metal electrical contact 35 to break the electrical circuit and extinguish light 10.

A wire 55 is soldered to the metal electrical contact 35 at the inside of non-conductive cover 40. The wire 55 runs through a hole in the circuit board holder 45 and connects to the circuit board 60. LED 65 is soldered on the circuit side of the circuit board 60 and oriented to allow the beam to shine away from circuit board 60 and through collimator 25 that also acts as lens cover that protects LED 65 and circuit board 60. The tapered outside diameter of collimator 25 provides a surface that allows a threaded ring 75 to hold collimator 25 in place inside the cylindrical head 20. The threaded internal diameter holds collimator 25 in place and seals the face against the shoulder. Plastic collimator 25 also acts as a protector for LED 65 and electronic components against the outside environment.

In operation, the tubular metal body that forms the first portion 10 not only acts as the storage area for a 3-volt lithium battery 30, but also is part of the electrical and thermal circuit. The negative-end 80 of battery 30 is grounded against the closed end of the tubular metal body of first portion 15, which completes the circuit when the positive contact of battery 30 is forced against circuit board contact 35.

Longitudinal pressure is applied, in the direction of arrow 85, to the battery 30 as the body of first portion 15 is screwed in a clockwise motion into the cylindrical head of second portion 20, moving the positive contact of battery 30 against the metal contact 35 that is staked into a nonconductive cover 40. Current is conducted through contact 35 along an insulated wire 55 and through a hole in the circuit board 60, at which point the wire 55 is soldered to circuit board 60.

Power is transmitted and controlled by the electrical circuit and electronic components soldered to the circuit board 60. LED 65 is soldered to circuit board 60, which, in conjunction with circuit board holder 45, acts as a heat sink and conducts heat into the metal body (e.g., portions 15 and 20) of light 10. This heat sink combination advantageously maintains LED 65 and extends the life of battery 30.

Light transmitted from LED 65 is guided and focused into, for example, a 10-degree beam, by an optical collimator 25. In one example, optical collimator 25 is located within 0.005 inches from the face of LED 65. Threaded ring 75 maintains this spacing by pressing against the tapered sides of collimator 25, forcing it against the inside face of the cylindrical head of second portion 20.

The battery power connection is broken and the light is turned off when the body of first portion 15 is unscrewed in a counter clockwise direction and resilient rubber gasket 50 forces battery 30 away from metal electrical contact 35.

The thread connecting the barrel of portion 15 and the cylindrical head of portion 20 operate together as the on/off switch. This reliable mechanism contributes to the long life cycle of light 10 in conjunction with the long shelf life of lithium battery 30, typically at least 10 years, and an almost limitless life of an Indium Gallium Nitride (InGaN) LED.

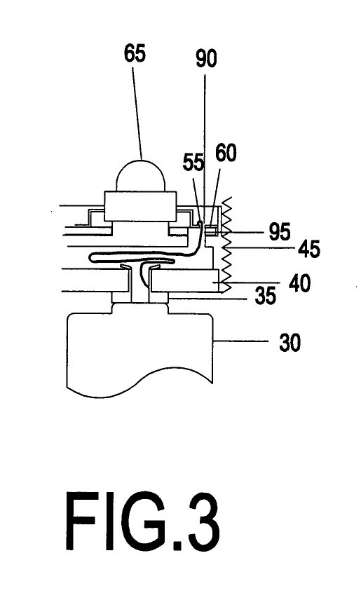

FIG. 3 is an assembly drawing that shows structure for connecting lithium battery 30 on one side of circuit board 60 to LED 65 on the other side of the board 60. Circuit board 60 on which the LED 65 is mounted has a contact point to which wire 55 is soldered. Wire 55 is then passed through a hole 90 in circuit board 60, and a hole 95 in circuit board holder 45 and then into a cavity counter-bored into circuit board holder 45. The free end of this wire 55 is then soldered to the electrical contact 35 that has been staked into and held by a nonconductive cover 40. All soldering and inspection is easily accomplished in full view of the technician before cover 40 is turned over and pressed into circuit board holder 45. Cover 40 is then pressed into circuit board holder 45, allowing wire 55 to coil inside where wire 55 remains protected.

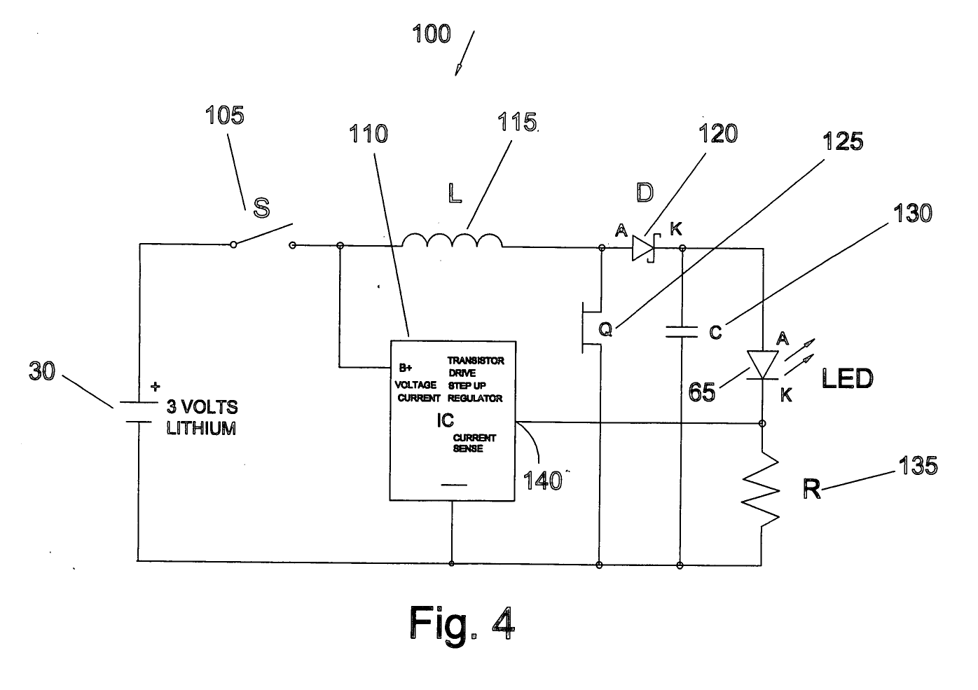

FIG. 4 illustrates an exemplary circuit 100 for light 10. This circuit advantageously provides steady LED current and thus steady light output, regardless of the battery voltage, until the battery is nearly exhausted. Circuit 100 includes a voltage converter and current regulator circuit. To implement the voltage converter and current regulator circuit, circuit 100 includes battery 30 (typically a single 3-Volt lithium cell), an on/off Switch 105, a voltage converter/current regulation controller integrated circuit (IC) 110, an inductor 115, a diode 120, with an anode side (A) and a cathode side (K), a switching transistor 125, an output capacitor 130, a current sensing resistor 135, and LED 65, with an anode side (A) and a cathode side (K).

In operation, the user closes switch 105 (e.g., by rotating portion 15 and/or portion 20), causing the battery voltage to be impressed upon inductor 115 and IC 110. IC 110, sensing that there is no voltage present at its current sense input port 140 causes its transistor drive output port 145 to go low (near 0 Volts), turning on transistor 125 for a minimum pre-set period of time, initiating a “soft start,” which minimizes an abrupt inrush of battery current. During this on time, all of the battery's voltage appears across inductor 115, and the resulting energy (proportional to the battery voltage and the transistor's on time) is stored as a magnetic flux in the core of inductor 115. At the end of the preset transistor on time, IC 110 turns transistor 125 off, and the magnetic flux collapses, inducing current in the inductor windings, causing a higher voltage than the battery voltage to appear at the anode side (A) of diode 120 (i.e., the inductor's resulting voltage is added to that of battery 30). This voltage can typically be greater than twice the battery voltage. For an increase in output voltage, there is a resulting increase in the current provided by the battery 30. The efficiency of conversion is the quotient of: (output voltage X output current) divided by (battery voltage X battery current). Diode 120 only allows current to flow in one direction towards LED 65, and the higher voltage from inductor 115, minus the small inherent voltage loss across diode 120 is impressed upon the anode side (A) of LED 65. This voltage causes a current to flow through LED 65 and current sense resistor 135, and thence back through battery 30. Since the same current flows through LED 65 and current sense resistor 135, the resultant voltage across resistor 135 is directly proportional to the current through LED 65, providing a means for IC 110 to monitor LED current. Capacitor 130 stores energy as it is released from inductor 115, and releases the energy to LED 65 when inductor 115 is not providing it, supplying an almost constant amount of energy to LED 65 when transistor 125 switches on and off as the process continues.

This process repeats with the transistor on time being gradually increased until the voltage at the IC sense input port 140 is indicative of the desired LED current. An increasing transistor on time causes more energy to be stored and subsequently released by inductor 115, thus increasing the current flowing through LED 65. This transistor on time is constantly adjusted by IC 110, keeping the LED current and thus the LED brightness constant regardless of the battery voltage, as long as the battery's voltage is within the limits of the circuit design.

Since current regulator IC 110 switches transistor 125 at a rate of approximately 1 Megahertz, inductor 115 and capacitor 130 can be physically small. A power field-effect transistor is advantageous for transistor 125 because of its extremely low drive current requirements, low voltage drop losses, and fast switching speeds. Diode 120 can be a Schottky type, which exhibits low voltage drop losses and fast recovery time. At these frequencies, it is advantageous to use a circuit board layout that includes short and relatively heavy copper traces. Circuit 100 provides small size and efficient operation from a low voltage battery, typically in the order of 75% to 90% power efficiency over the life of the battery.

Circuit 100 fits on the small circuit board 60 shown in FIG. 2. Controlling the threshold voltage regulates the LED driver current to typically cause furnishing approximately 85% of the maximum optical intensity of the LED.

Using the techniques described above can provide many advantages. One advantage is long shelf life. Another advantage is furnishing a high level light for a relatively extended period. Another advantage is visibly indicating battery deterioration over a relatively long period before exhaustion. Another advantage is furnishing a light stream visible over an extended distance. Another advantage is furnishing light for night vision in smoky conditions. Another advantage is diffusing heat. Another advantage is relatively easy storage readily available to the user for easy access. Another advantage is relatively small size that produces an abundance of light. Another advantage is an efficient electronic circuit to drive the light emitting diode (LED) to control the current load regulating the voltage applied to the LED. Another advantage is an efficiently collimated light beam. Another advantage is a reliable switch for selectively energizing the LED. Another advantage is using a single 1-watt LED to produce a high level of light. Another advantage is using a small, commercially available battery for powering the LED. An advantageous feature is a convenient structure for moving power from the battery side of a single-sided circuit board to the other side where the LED is located.

It is evident that those skilled in the art may now make numerous modifications of and departures from the specific apparatus and techniques disclosed herein. Consequently, the invention is to be construed as embracing each and every novel feature and novel combination of features present in or possessed by the apparatus and techniques herein disclosed and limited only by the spirit and scope of the appended claims.

1. A lithium battery powered LED light comprising:
a lithium battery power source;
a switch;
a Gallium Nitride Light Emitting Diode (LED) selectively electrically connected to the lithium battery by the switch;
a heat sink thermally coupled to the LED;
a voltage converter and current regulator circuit having a circuit contact electrically connected to the switch, the LED and the lithium battery constructed and arranged to provide a predetermined voltage and current to the LED when connected to the lithium battery; and
a housing within which the lithium battery, the switch, the LED, the heat sink and the voltage converter and current regulator circuit are located.

2. A lithium battery powered LED light in accordance with claim 1 wherein the housing comprises a metal body comprising the heat sink.

3. A lithium battery powered LED light in accordance with claim 1 wherein the housing includes a metal body having threaded parts comprising the switch, which is closed when the threaded parts of the housing are screwed together in a first direction, thereby urging the lithium battery against the circuit contact, causing activation of the voltage converter and current regulator circuit and causing the LED to emit light.

4. A lithium battery powered LED light in accordance with claim 3 and further comprising, a compressed rubber ring configured to urge the battery away from the circuit contact and deactivate the voltage converter and current regulator circuit when the threaded parts of the housing are turned in a second direction opposed to the first direction.

5. A lithium battery powered LED light in accordance with claim 3 wherein the threaded parts comprise outside-diameter threads and inside-diameter threads that are moveably coupled to each other.

6. A lithium battery powered LED light in accordance with claim 1 wherein the lithium battery and the Gallium Nitride LED are constructed and arranged to have a shelf life of at least 10 years.

7. A lithium battery powered LED light in accordance with claim 1 and further comprising a collimator optically coupled to the LED.

8. A lithium battery powered LED light in accordance with claim 7 wherein the collimator comprises an optical-grade-acrylic-plastic.

9. A lithium battery powered LED light in accordance with claim 7 wherein the collimator is constructed and arranged to produce a substantially 10-degree light beam when the LED is on.

10. A light in accordance with claim 7 wherein the collimator is integrally coupled to the housing, thereby acting as a protective lens at a front end of the light to protect the LED and electronic components included within the housing.

11. A lithium battery powered LED light in accordance with claim 1 wherein the LED is constructed and arranged to emit light waves at a frequency that is seen by the human eye as blue/green or teal in color.

12. A lithium battery powered LED light in accordance with claim 1 wherein the LED has a brightness such that the LED can be seen from a distance of over 1 mile.

13. A lithium battery powered LED light in accordance with claim 1 wherein the voltage converter and current regulator circuit is constructed and arranged to provide at least 85% power efficiency.

14. A lithium battery powered LED light in accordance with claim 1 wherein the LED is permanently mounted on a metal circuit board holder comprising,
a thermally conductive path thermally coupled to the LED and a metal body of the housing.

15. A lithium battery powered LED light in accordance with claim 14 wherein the metal circuit board holder comprises a first passage, the lithium battery powered LED light further comprising:
a one-sided circuit board including a second passage aligned with the first passage;
a connecting wire passing through the first and second passages, the connecting wire electrically connected to the circuit board and to a contact for the lithium battery; and
a cavity defined by the housing within which portions of the connecting wire are stored.

16. A lithium battery powered LED light in accordance with claim 1 wherein the housing comprises polished metal in the form of a column.

17. A lithium battery powered LED light in accordance with claim 16 wherein the housing does not include any switches or buttons external to the housing.

18. A lithium battery powered LED light in accordance with claim 1 wherein the LED is electrically connected to an electronic circuit board that includes the voltage converter and current regulator circuit.

19. A lithium battery powered LED light in accordance with claim 18 wherein the electronic circuit board is a one-sided circuit board and the lithium battery is located on a side of the circuit board opposite of where the LED is located, the circuit board further comprising a passage
constructed and arranged to allow a wire connected to the LED to pass through the passage in the circuit board to a connection that is in contact with the battery.

20. A lithium battery powered LED light in accordance with claim 1 wherein the voltage converter and current regulator circuit is constructed and arranged to provide a minimum of 2.7 volts to the Gallium Nitride LED.

21. A lithium battery powered LED light in accordance with claim 1 wherein the Gallium Nitride LED is a 1-watt LED and the Lithium battery is a 3-volt lithium battery, and wherein the voltage converter and current regulator circuit is constructed and arranged to power the 1-watt Gallium Nitride LED using the 3-volt lithium battery.

22. A lithium battery powered LED light in accordance with claim 20 wherein the voltage converter and current regulator circuit is constructed and arranged to allow the 3-volt lithium battery to provide at least six hours of continual light from the 1-watt LED.

23. A lithium battery powered LED light in accordance with claim 1 wherein the voltage converter and current regulator circuit further comprises:
an inductor electrically connected to the switch;
a Schottky type diode including an anode side and a cathode side, the anode side electrically connected to the inductor;
a current sensing resistor electrically connected to the LED;
an output capacitor electrically connected to the cathode side of the Schottky type diode;
a switching transistor electrically connected to the anode side of the Schottky type diode; and
a voltage converter and current regulator controller IC including a voltage sense port electrically connected to the inductor, a current sensing port electrically connected to the current sensing resistor, and a transistor driving port electrically connected to the switching transistor.
